(19) United States
(12) Patent Application Publication
(10) Pub. No.: US 2013/0136510 A1
(43) Pub. Date: May 30, 2013

(54) Fixing Unit, Image Forming Apparatus Including the Same, and Method for Separating Recording Medium

(71) Applicant: Tomohiro Watatani, Osaka (JP)

(72) Inventor: Tomohiro Watatani, Osaka (JP)

(21) Appl. No.: 13/691,244

(22) Filed: Nov. 30, 2012

(30) Foreign Application Priority Data
Nov. 30, 2011 (JP) 2011-261199

(51) Int. Cl. G03G 15/20

(52) U.S. Cl. CPC G03G 15/2085
USPC 399/323

(57) ABSTRACT

A fixing unit includes a heating member, a pressing member, a casing, a separating member, and an urging member. The separating member has a separation claw and a rotating unit. The urging member urges the separation claw toward the surface of the heating member. The rotating unit has an engaging portion and guide surfaces opposing at an interval smaller than that of the engaging portion. The supporting portion includes an engagement supporting portion that rotatably engages the engaging portion and an insertion opening. The separating member rotates to retract guide surfaces from a position facing the inner wall surfaces of the insertion opening. The guide surfaces oppose the inner wall surfaces of the insertion opening to bring the engaging portion to the engagement supporting portion and thereafter mounting the heating member on the casing.

### INCORPORATION BY REFERENCE

This application is based upon and claims the benefit of priority from the corresponding Japanese Patent application No. 2011-261199, filed Nov. 30, 2011, the entire contents of which is incorporated herein by reference.

### BACKGROUND

Unless otherwise indicated herein, the description in this section is not prior art to the claims in this application and is not admitted to be prior art by inclusion in this section. The present disclosure relates to a fixing unit for use in image forming apparatuses, possibly including copying machines, printers, facsimile machines, and multifunction peripherals, among other possibilities. In particular, the present disclosure relates to an image forming apparatus including a fixing unit that separates a recording medium from the surface of a heating member.

In some embodiments, a fixing unit may include an unfixed toner image between a heating member and a pressing member. A recording medium may be fed to the fixing unit such that the heating member fuses toner on the recording medium by a heating action. In addition, the pressing member may fix the fused toner image onto the recording medium by a pressing action.

In some instances, this fixing unit may sometimes have a separating member with a separation claw to prevent the recording medium from winding around the heating member. The separating member may be mounted to the casing of the fixing unit in such a manner that it opposes (e.g., prevents, averts, and/or stops) the surface of the recording medium from coming into contact with the heating member, possibly while keeping a predetermined distance between them.

An example of the fixing unit includes a first casing and a second casing. A heating roller and a pressure roller are rotatably fitted (e.g., rotated and fitted) in the first casing. A separating member is rotatably fitted in the second casing. The separating member includes a separation claw and a rotating shaft.

A spring member may contract to “urge” (e.g., move, pull, and/or lower) the separation claw toward the surface of the heating roller provided between the separating member and the second casing. The second casing has a slot and a bearing disposed inside the slot. The rotating shaft of the separating member has a second shaft having a flat portion and an arc portion. The outer circumference of the rotating shaft has a protruding portion with a curvature. The second casing has a diagonal rib which opposes the protruding portion by making contact with it when the rotating shaft is rotated against the urging (e.g., contracting) force of the spring member. When the separating member is to be mounted to the second casing, the flat portion of the second shaft is inserted into the opposing slot of the second casing until the arc portion of the second shaft reaches the bearing portion of the second casing. The rotating shaft may be rotated with the arc portion of the second shaft on the bearing portion of the second casing. The rotating shaft may be rotated until the protruding portion of the rotating shaft makes contact with the diagonal rib of the second casing. This allows the rotating shaft to rotate in a predetermined range until the protruding portion makes contact with the diagonal rib.

However, the rotational state of the rotating shaft may be controlled by the spring member and urged toward the diagonal rib. In some instances, the second casing is mounted on the first casing and the rotating shaft is rotated against the contracting force of the spring member. This rotation may cause the protruding portion of the rotating shaft to be separated from the diagonal rib but in a predetermined range such that the separating member may be urged to the surface of the heating roller. As such, the separating member may be mounted so as to come in contact with the surface of the heating roller.

For the fixing unit described above, it is necessary to include the protruding portion on the rotating shaft of the separating member and to utilize the diagonal rib on the second casing. In some instances, such implementations may complicate the configurations of the separating member and the second casing. Furthermore, the rotating shaft of the separating member has to be forced into rotating until the protruding portion of the rotating shaft makes contact with the diagonal rib of the second casing. In addition, when the second casing fitted is mounted to the first casing fitted, the position of the separating member relative to the surface of the heating roller may become unstable, which makes it difficult to mount the separating member. Thus, the improvements described herein provide enhanced solutions involving engineering robustness and mechanical efficiency.

### SUMMARY

A fixing unit according to an embodiment of the present disclosure is provided that includes a heating member, a pressing member, a casing, a separating member, and an urging member. The heating member is heated by a heat source. The pressing member is pressed against with the heating member to form a nip so as to fuse an unfixed toner image on a recording medium subjected to a fixing process. The casing includes a supporting member, where the casing rotatably supports the pressing member and the heating member. The separating member includes a separation claw that separates the recording medium from a surface of the heating member by making contact with the surface of the heating member. A rotating unit rotates the separation claw such that the separation claw makes contact with the surface of the heating member. The rotating unit includes an engaging portion and guide surfaces, where at least part of the engaging portion is cylindrical in shape and an interval between the guide surfaces is smaller than a diameter of the engaging portion. An engagement supporting portion rotatably engages the engaging portion. An insertion opening extends toward the engagement supporting portion at an interval smaller than the diameter of engaging portion and larger than the interval between the guide surfaces. The separating member rotates and retracts the guide surfaces from a position facing inner wall surfaces of the insertion opening by inserting the engaging portion into the insertion opening. The guide surfaces are opposed to the inner wall surfaces of the insertion opening to move the engaging portion to the engagement supporting portion. The heating member is mounted on the casing.

An image forming apparatus according to another embodiment of the present disclosure includes a heating member, a pressing member, a casing, a separating member, and an urging member. The heating member is heated by a heat source. The pressing member is pressed against with the heating member to form a nip so as to fuse an unfixed toner image on a recording medium subjected to a fixing process. The casing includes a supporting member, where the casing rotatably supports the pressing member and the heating member. The separating member includes a separation claw that separates the recording medium from a surface of the heating member by making contact with the surface of the heating member. A rotating unit rotates the separation claw such that the separation claw makes contact with the surface of the heating member. The rotating unit includes an engaging portion and guide surfaces, where at least part of the engaging portion is cylindrical in shape and an interval between the guide surfaces is smaller than a diameter of the engaging portion. An engagement supporting portion rotatably engages the engaging portion. An insertion opening extends toward the engagement supporting portion at an interval smaller than the diameter of engaging portion and larger than the interval between the guide surfaces. The separating member rotates and retracts the guide surfaces from a position facing inner wall surfaces of the insertion opening by inserting the engaging portion into the insertion opening. The guide surfaces opposed to the inner wall surfaces of the insertion opening to move the engaging portion to the engagement supporting portion. The heating member is mounted on the casing.

A method according to another embodiment of the present disclosure includes a fixing unit rotating a pressing member and a heating member, where the pressing member and the heating member are rotatably supported in a casing of the fixing unit. The fixing unit presses the pressing member against the heating member to form a nip and sending a recording medium through the nip to fuse an unfixed toner image on the recording medium. The fixing unit moves a rotating unit such that a separating member rotates towards the heating member, where the rotating unit moves in response to movement of an urging member. The fixing unit separates the recording medium from a surface of the heating member using a separation claw, where the separation claw prevents the recording medium from winding around the heating member.

These as well as other aspects, advantages, and alternatives, will become apparent to those of ordinary skill in the art by reading the following brief description, with reference where appropriate to the accompanying drawings.

### BRIEF DESCRIPTION OF THE DRAWINGS

FIG. 1 a diagram showing, in outline, the overall configuration of an image forming apparatus equipped with a fixing unit, according to an example embodiment of the present disclosure;

FIG. 2 is a side view showing the internal configuration of the fixing unit, according to an example embodiment;

FIG. 3 is a view showing a configuration for supporting a rotating unit of a separating member with a supporting portion of a casing, according to an example embodiment;

FIG. 4 is a view showing the separating member, according to an example embodiment;

FIG. 5 is a view showing the supporting portion of the casing, according to an example embodiment;

FIG. 6 is a side view showing a first process for mounting the separating member to the casing, according to an example embodiment;

FIG. 7 is a side view showing a second process for mounting the separating member to the casing, according to an example embodiment;

FIG. 8 is a side view showing a third process for mounting the separating member to the casing, according to an example embodiment; and

FIG. 9 is a side view showing a fourth process for mounting the separating member to the casing, according to an example embodiment.

### DETAILED DESCRIPTION

Although an embodiment of the present disclosure will be described herein with reference to the drawings, the present disclosure is not limited to these embodiments as other implementations are also possible. Applications of the disclosure and terms presented here are not limited thereto.

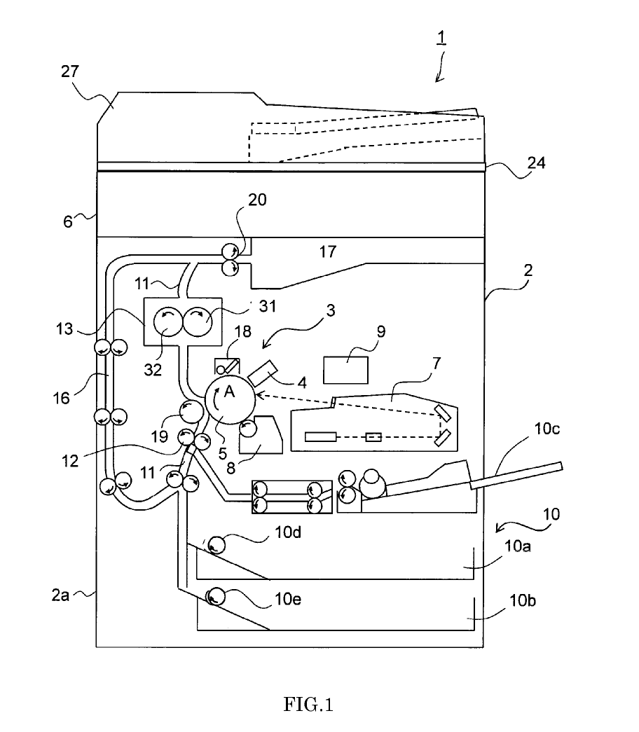

FIG. 1 is a diagram showing the overall configuration of an internal-paper-output type image forming apparatus. An image forming apparatus 1 has a cassette-type paper feeding unit 10 at the lower part thereof. The paper feeding unit 10 has two upper and lower paper cassettes 10a and 10b. The paper cassettes 10a and 10b accommodate stacked sheets of paper before printing. The sheets of paper accommodated in the paper cassettes 10a and 10b are fed out one by one with a paper pickup roller 10d and 10e, respectively. The fed out paper is sent to a paper conveying path 11.

A manual paper feeding tray 10c is positioned on the right side of the image forming apparatus 1. The manual paper feeding tray 10c can also accommodate different sizes of paper from those of the paper cassettes 10a and 10b. The paper placed in the manual paper feeding tray 10c is fed out to the paper conveying path 11.

The paper conveying path 11 extends in a vertical direction of the apparatus main body 2 on the left side of the paper feeding unit 10. The paper fed out from the paper feeding unit 10 is conveyed to a registration roller pair 12 at the upper part of the paper conveying path 11. The registration roller pair 12 feeds the paper toward an image forming unit 3 in synchronization with the timing at which a toner image is transferred to the paper.

A document reader 6 is located at the upper part of the image forming apparatus 1. A platen (document holder) 24 can be opened and positioned on the upper surface of the document reader 6. Furthermore, a document conveying unit 27 is mounted on the platen 24. When documents are to be copied, the documents placed on the document conveying unit 27 are separated one by one and are fed to the document reader, where image data is read from the documents.

The image forming unit 3 is positioned substantially at the center of the image forming apparatus 1. The image forming unit 3 includes a photoreceptor 5 serving as an image bearing member, and furthermore, a charging unit 4, an exposing unit 7, a developing unit 8, a transfer roller 19, and a cleaning unit 18 around the photoreceptor 5 in this order along the rotating direction thereof (in the direction of arrow A in FIG. 1). Toner is supplied to the developing unit 8 from a toner container 9. The cleaning unit 18 has a cleaning member, such as a blade, a brush, or a polishing roller, strips off toner remaining on the surface of the photoreceptor 5 with the cleaning member, and recovers it.

When the surface of the photoreceptor 5 is uniformly charged at a predetermined polarity and potential by the charging unit 4, the exposing unit 7 forms a static latent image of the document image on the photoreceptor 5 on the basis of the document image data read by the document reader 6.

The developing unit 8 supplies the charged toner to the surface of the photoreceptor 5 and develops the static latent image on the photoreceptor 5 to form a toner image. The toner image on the photoreceptor 5 is transferred onto paper by the transfer roller 19. The paper to which the toner image is transferred is conveyed to the fixing unit 13 located at the upper part of the paper conveying path 11. After the toner image is transferred onto the paper, toner remaining on the surface of the photoreceptor 5 is cleaned off and recovered by the cleaning unit 18, and residual electrical charge on the surface of the photoreceptor 5 is removed by a static eliminator (not shown).

The fixing unit 13 includes a heating roller 31 and a pressure roller 32 for applying heat and pressure, respectively, to the paper on which the toner image is transferred. As such, the heating roller 31 and the pressure roller 32 fix the toner image on the paper by thermal fusion. The paper on which the toner image is fixed is conveyed to the upper right through the paper conveying path 11 and is output to an internal paper output unit 17 serving as an output section by the output roller pair 20.

A reverse conveying path 16 branches from the paper conveying path 11 between the fixing unit 13 and the output roller pair 20. The reverse conveying path 16 is used, after the toner image is fixed to one of the surfaces of the paper, to form the toner image on the other surface of the paper as needed. The reverse conveying path 16 covers the periphery of the fixing unit 13 from above the fixing unit 13, extends downward between the paper conveying path 11 and a side 2a of the apparatus main body 2, and merges with the paper conveying path 11 in the vicinity of the registration roller pair 12. For two-sided printing, while the paper in which the toner image is fixed to one surface is output to the internal paper output unit 17, the output roller pair 20 is reversed at the timing at which the trailing end of the paper passes through the branch point of the paper conveying path 11 and the reverse conveying path 16. This causes the paper to be switched back to the reverse conveying path 16, with the print surface thereof reversed inside out, and to be conveyed again from the reverse conveying path 16 to the registration roller pair 12 in the paper conveying path 11. Thereafter, when the toner image is transferred also onto the other side of the paper by the image forming unit 3, the paper is subjected to a fixing process by the fixing unit 13 and is output to the internal paper output unit 17.

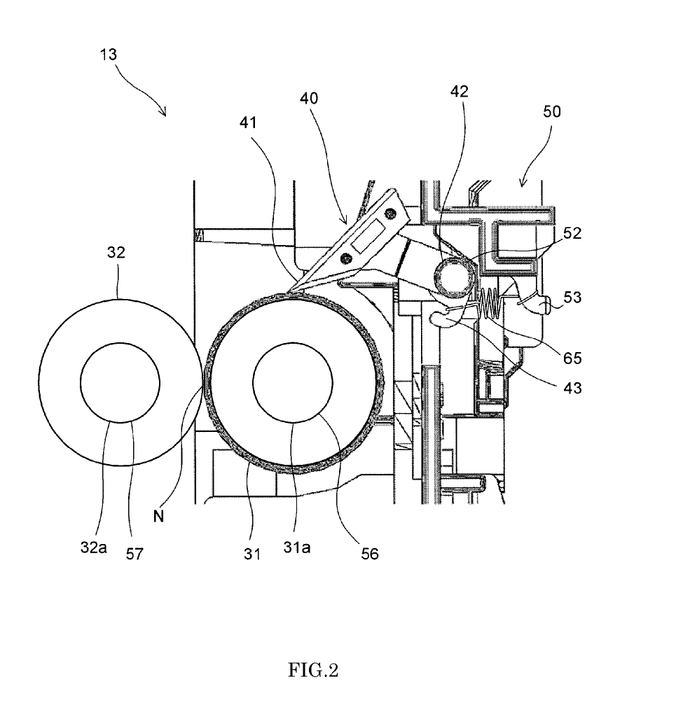

FIG. 2 is a side view showing the internal configuration of the fixing unit 13 used in the image forming apparatus 1 described above. The fixing unit 13 employs a roller fixing system and includes the heating roller 31 serving as a heating member, the pressure roller 32 serving as a pressing member, separating members 40, and a casing 50. The heating roller 31, the pressure roller 32, and the separating members 40 are supported by the casing 50.

The heating roller 31 is formed by coating a cylindrical core made of metal having high thermal conductivity, such as aluminum and iron, with a fluoroplastic coat or tube. The core of the heating roller 31 accommodates a heater serving as a heat source (not shown), such as a halogen lamp and a xenon lamp. The heating roller 31 is heated to a predetermined temperature by the heater.

The heating roller 31 is rotatably supported by the casing 50 (e.g., supported by casing 50 such that it can rotate). A pair of rotation shafts 31a are provided at both ends in the axial direction of the heating roller 31. The rotation shafts 31a rotatably engage (e.g., rotate) with bearing portions formed at the casing 50.

The pressure roller 32 is made by forming an elastic layer, such as silicone rubber, around a cylindrical base material made of synthetic resin, metal, or another material. In addition, the surface of the elastic layer may be coated with resin having high releasing capabilities, such as fluoroplastic.

The pressure roller 32 is rotatably supported by the casing 50 (e.g., supported by casing 50 such that it can rotate). A pair of rotation shafts 32a are provided at both ends in the axial direction of the pressure roller 32. The rotation shafts 32a rotatably engage with bearing portions formed at the casing 50. The pressure roller 32 is in contact with the heating roller 31 while applying a predetermined pressure on roller 31. When the pressure roller 32 is rotated by a driving source, such as a motor, the heating roller 31 is also rotated together therewith. Alternatively, it is also possible that the heating roller 31 is rotated by a driving source, and the pressure roller 32 is rotated as the heating roller 31 rotates.

A nip N is formed at a portion where the heating roller 31 and the pressure roller 32 are in contact while rotating in opposite directions. Paper is conveyed from the upstream side in the paper conveying direction (lower part in FIG. 2) to the nip N, where the paper is heated and pressurized by the heating roller 31 and the pressure roller 32, respectively. As such, the particle toner on the paper is fixed by thermal fusion.

The separating members 40 separate the paper subjected to the fixing process from the surface of the heating roller 31. The separating members 40 are arranged side by side at a plurality of locations in the axial direction of the heating roller 31. The separating members 40 each have a separation claw 41, a rotating unit 42, and a spring hook 43 (hook).

The separation claws 41 are positioned downstream of the nip N in the rotating direction of the heating roller 31 (clockwise in FIG. 2). The tips of the separation claws 41 make contact with the surface of the heating roller 31. Using the separation claws 41, the paper subjected to the fixing process at the nip N is separated from the surface of the heating roller 31 and is thereafter conveyed downstream in the paper conveying direction (upward in FIG. 2).

The rotating unit 42 rotates the separation claw 41 in a manner to bring it in and out of contact with the surface of the heating roller 31. Further, rotating unit 42 is rotatably supported by a pair of supporting portions 52 provided at the casing 50.

The spring hook 43 is provided at the opposite side from the separation claw 41 with respect to the rotating unit 42 and secures a hook portion at one end of a spring member 65 serving as an urging member. The spring member 65 is formed using a tensile coil spring. A hook portion at the other end of the spring member 65 is secured using a protruding piece 53 provided at the casing 50. The separating members 40 are each urged by the spring member 65 counterclockwise in FIG. 2 around the rotating unit 42, which brings the separation claws 41 into contact with the surface of the heating roller 31. As such, the paper that attaches to the surface of the heating roller 31 is separated from the surface of the heating roller 31 using separation claws 41.

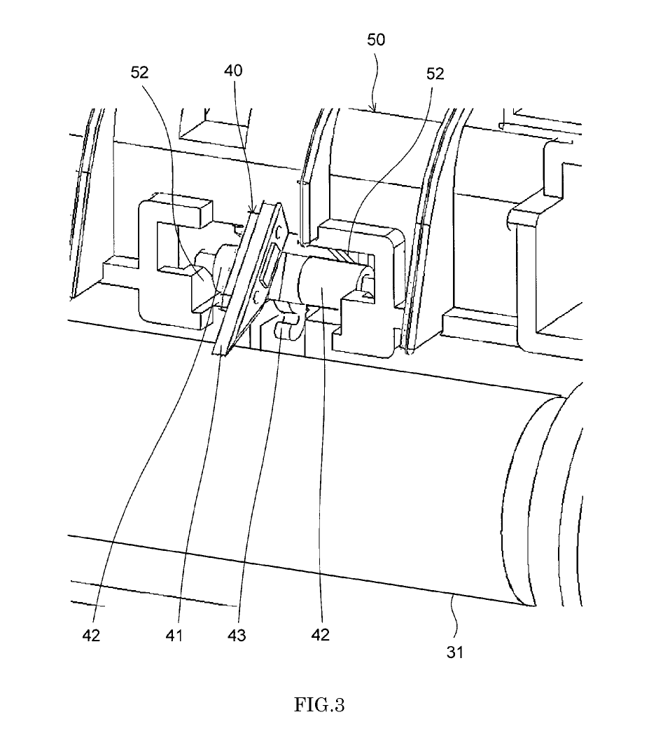

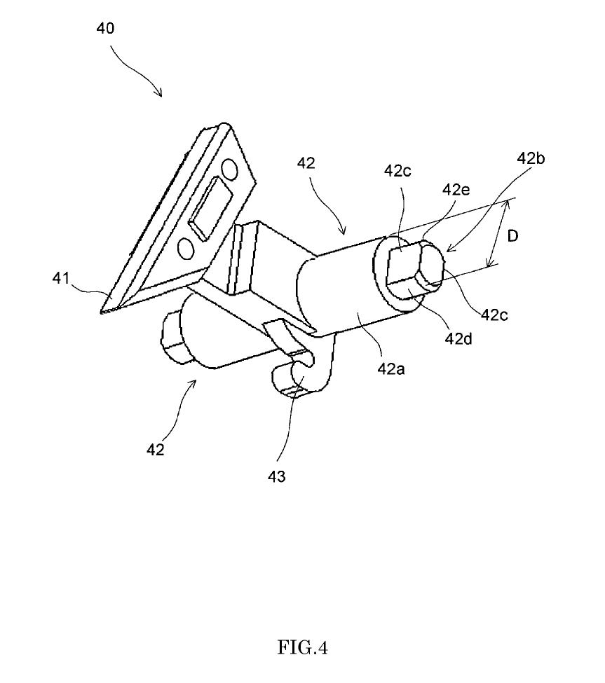

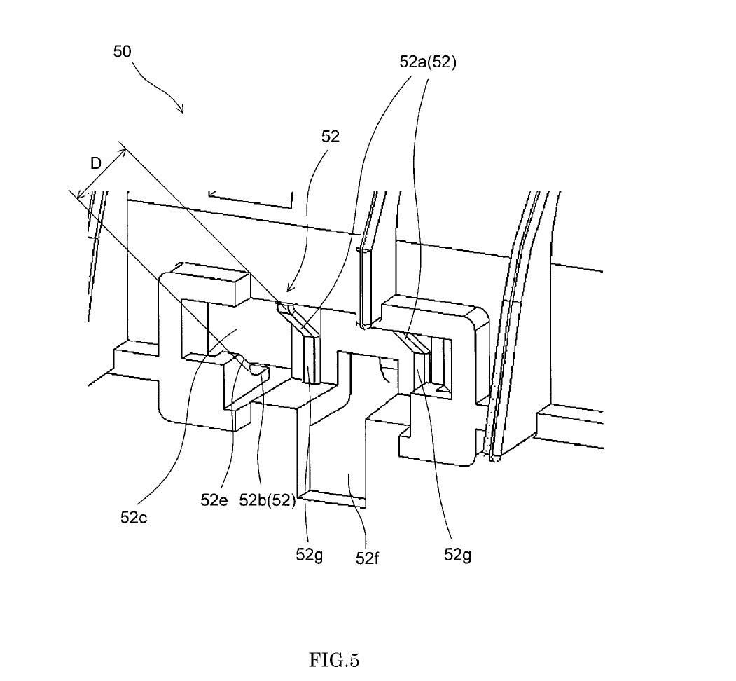

Referring to FIGS. 3 to 5, a configuration for supporting the rotating unit 42 for the separating member 40 with the supporting portions 52 of the casing 50 will be described. FIG. 3 is a perspective view showing the configuration for supporting the rotating unit 42 with the supporting portions 52. FIG. 4 is a perspective view showing the configuration of the separating member 40. FIG. 5 is a perspective view showing the configuration of the supporting portions 52.

As shown in FIG. 3, the separating member 40 is provided with the separation claws 41 and the spring hook 43 substantially at the center of the rotating unit 42, with respect to the ends of rotating unit 42 in each axial direction.

The casing 50 has a space that accommodates the rotating unit 42 and the spring hook 43. The space accommodates the supporting portions 52 opposing the rotating unit 42. It is possible to insert the separating member 40 into the space in the casing 50 to mount the rotating unit 42 to the supporting portions 52 in a rotatable manner.

As shown in FIG. 4, the rotating unit 42 has a first shaft 42a and second shafts 42b. The first shaft 42a is provided by a cylindrical member extending from the base of the separation claw 41 toward the end of the cylindrical member in each axial direction. The second shafts 42b extend further from the first shaft 42a toward the end of the axial direction and each have a pair of opposing flat portions 42c and a pair of opposing arc portions 42d and 42e.

The pair of flat portions 42c each include a flat surface having a width smaller than the diameter of the first shaft 42a (the width in the direction perpendicular to the axial direction of the first shaft 42a). The pair of arc portions 42d and 42e each include an arc surface having an arc with a diameter smaller than the diameter of the first shaft 42a. The arc portion 42d is provided on the second shaft 42b so as to face in the orientation of the tip of the separation claw 41. The arc portion 42e is provided on the second shaft 42b so as to face in an opposite direction as compared to the tip of the separation claw 41. The pair of arc portions 42d and 42e may be combined to amount to an arc surface with the same diameter as that of the first shaft 42a.

The arc portion 42d and part of the outer circumferential surface of the first shaft 42a may provide for “an engaging portion.” Referring back to FIGS. 2 and 3, the separating member 40 may be mounted to the casing 50. As such, the engaging portion may rotatably engage with respect to the supporting portions 52. The pair of flat portions 42c in FIG. 4 may be used as guide surfaces and may be configured to guide the rotating unit 42 toward the supporting portions 52.

As shown in FIG. 5, the supporting portions 52 of the casing 50 have a pair of first engagement supporting portions 52a and a pair of second engagement supporting portions 52b (the second engagement supporting portion 52b at the right in FIG. 5 is not shown due to the angle of casing 50 illustrated in the figure). The first engagement supporting portions 52a and the second engagement supporting portions 52b establish “an engagement supporting portion” that rotatably engages the rotating unit 42. The first engagement supporting portions 52a are slopes that decline downward from the insertion side toward contact surfaces 52g. The second engagement supporting portions 52b are positioned outside the first engagement supporting portions 52a of the supporting portion 52 (at both ends of the accommodation space for the rotating unit 42). In addition, the second engagement supporting portions 52b are each shaped with an arc having substantially the same diameter as those of the arc portions 42d and 42e of the second shaft 42b.

When the separating member 40 is mounted to the casing 50, the first shaft 42a (see FIG. 4) of the rotating unit 42 may engage with (and/or possibly rotate with respect to) the first engagement supporting portions 52a. In addition, the arc portions 42d (see FIG. 4) of the rotating unit 42 (the second shafts 42b) may engage with (and/or possibly rotate with respect to) the second engagement supporting portions 52b such that the rotating unit 42 is supported by the casing 50.

Accordingly, the first engagement supporting portions 52a and the second engagement supporting portions 52b may be separated at distance D shown in FIG. 5 in cross-sectional view in the axial direction of the rotating unit 42. The distance D is set to substantially the same width as the distance D between the arc portion 42d of the second shaft 42b and part of the outer circumferential surface of the first shaft 42a (see FIG. 4). It should be noted that the distance D in FIG. 4 and the distance D in FIG. 5 are substantially the same so that the engaging portion can rotate without making physical contact with the first engagement supporting portions 52a and the second engagement supporting portions 52b.

A wall surface 52e is provided in the vicinity of each second engagement supporting portion 52b. From the view provided in FIG. 5, the wall surface 52e is formed parallel to the first engagement supporting portion 52a. In some instances, the wall surface 52e and the wall surface of the first engagement supporting portion 52a may form a gap serving as an insertion opening 52c. The insertion opening 52c extends toward or past the first engagement supporting portion 52a and the second engagement supporting portion 52b (engagement supporting portion). In some instances, the insertion opening 52c may extend at a width smaller than the distance D to allow the second shaft 42b to be inserted therein. Further, in some instances, the second shaft 42b may be inserted with the pair of flat portions 42c (see FIG. 4) of the second shaft 42b opposed or closely aligning to the inner wall surfaces (guide surfaces) of the insertion opening 52c.

Contact surfaces 52g are formed below both of the first engagement supporting portions 52a. The contact surfaces 52g are vertical surfaces extending downward from the first engagement supporting portions 52a. When the separating member 40 is mounted to the casing 50, the outer circumferential surface of the first shaft 42a (see FIG. 4) may come into contact with the contact surface 52g together with the first engagement supporting portions 52a.

An opening 52f that opens downward is formed between the pair of first engagement supporting portions 52a. This opening 52f prevents physical contact from being made between the spring hook 43 of the separating member 40 (see FIG. 4) and the casing 50 when the separating member 40 rotates.

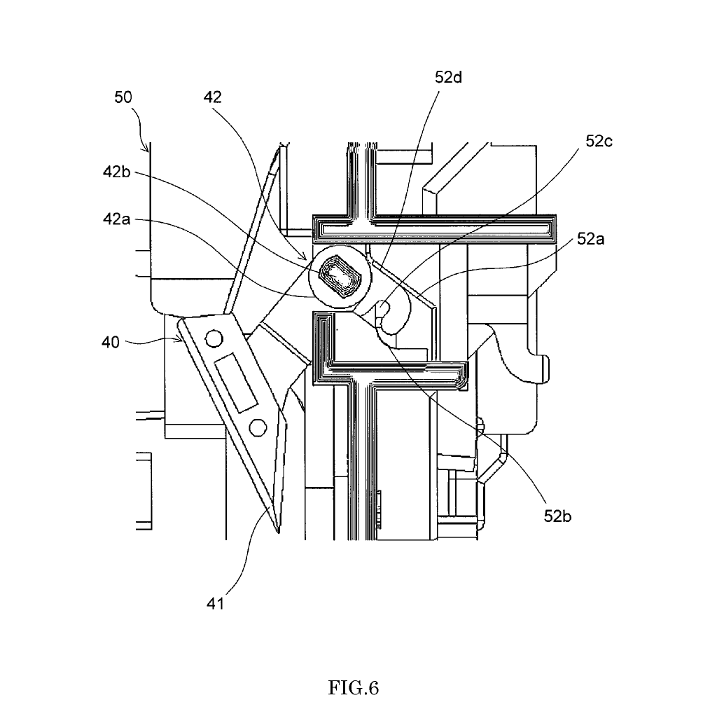

The separating member 40 is mounted to the casing 50 in the order of operations illustrated in FIGS. 6 to 9. FIGS. 6 to 9 are side views showing operations for mounting the separating member 40 to the casing 50.

As shown in FIG. 6, the movement of rotating unit 42 may be opposed or controlled by the inlet of the insertion opening 52c such that the separation claw 41 of the separating member 40 may be positioned downward toward the heating roller 31 (see FIG. 2). The two flat portions 42c of each second shaft 42b are opposed to the inner wall surfaces of the insertion opening 52c. From this state, the rotating unit 42 is inserted into the insertion opening 52c. When the rotating unit 42 is inserted, the flat portions 42c of each second shaft 42b move in the insertion opening 52c toward the first and second engagement supporting portions 52a and 52b, and the first shaft 42a moves toward the first and second engagement supporting portions 52a and 52b while maintaining contact with wall surfaces 52d extending from the first engagement supporting portions 52a to the insertion side. Since this configuration allows the rotating unit 42 to be inserted, with the first shaft 42a in contact with the wall surfaces 52d, the rotating unit 42 can be moved easily and reliably toward the first and second engagement supporting portions 52a and 52b.

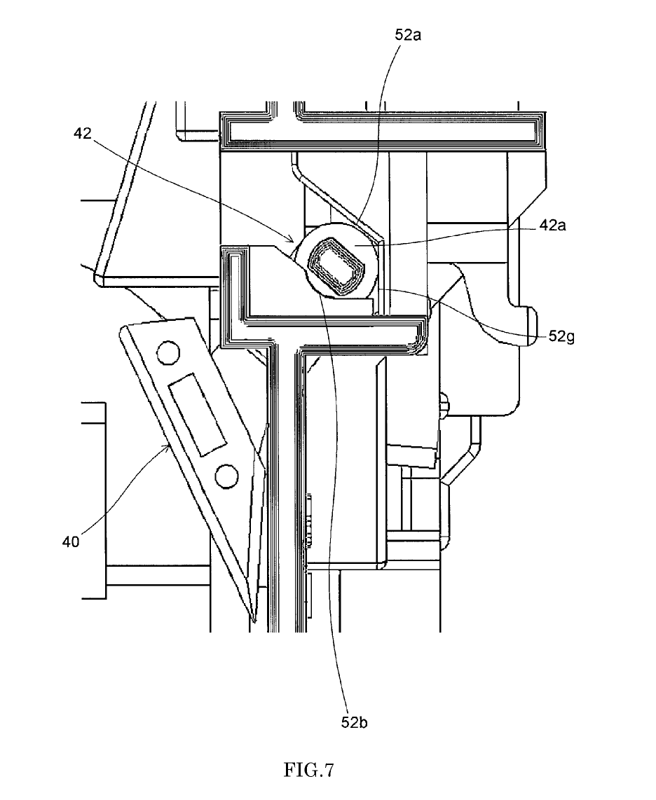

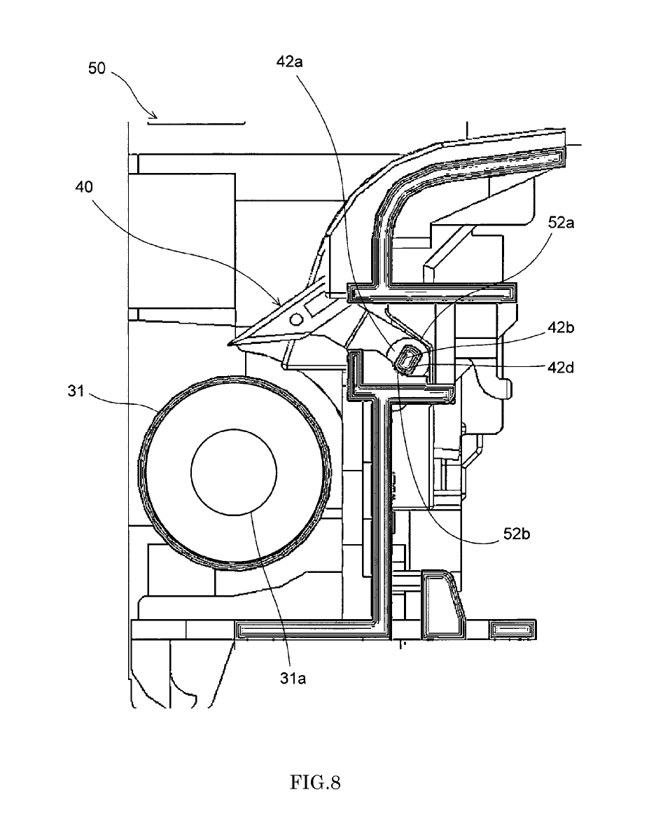

As shown in FIG. 7, when the rotating unit 42 is inserted until the first shaft 42a comes into contact with the contact surfaces 52g, with the flat portions 42c of the second shafts 42b opposed to (e.g., closely aligned with) the inner wall surfaces of the insertion opening 52c, the rotating unit 42 reaches the first and second engagement supporting portions 52a and 52b. Next, as shown in FIG. 8, the separating member 40 is rotated clockwise substantially at 90 degrees in the state in which the rotating unit 42 has reached the first and second engagement supporting portions 52a and 52b.

In the state shown in FIG. 8, the first shaft 42a is supported by the first engagement supporting portions 52a, and the arc portions 42d of the second shafts 42b are supported by the second engagement supporting portions 52b. The rotation shaft 31a of the heating roller 31 is brought into engagement with the bearing portion of the casing 50, with the separating member 40 maintained in this state, so that the heating roller 31 is mounted to the casing 50.

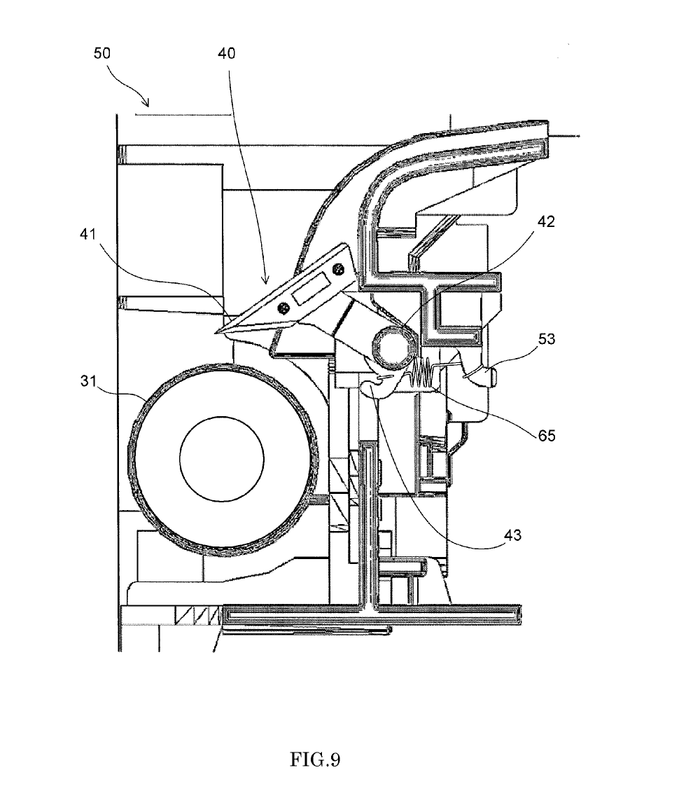

Next, as shown in FIG. 9, to operate the spring member 65 between the separating member 40 and the casing 50, one of the hook portions of the spring member 65 is hooked on the spring hook 43 of the separating member 40, and the other hook portion of the spring member 65 is hooked on the protruding piece 53 of the casing 50. When the spring member 65 is secured to the separating member 40 and the casing 50, the contracting force of spring member 65 urges the separating member 40 to rotate counterclockwise in FIG. 9 around the rotating unit 42. Thus, the separation claw 41 comes into contact with the surface of the heating roller 31 (see FIG. 2). In some instances, the rotating unit 42 rotates counterclockwise from the state in FIG. 9 until the separation claw 41 comes into contact with the surface of the heating roller 31. The first shaft 42a is supported by the first engagement supporting portions 52a, and the arc portions 42d of the second shafts 42b are supported by the second engagement supporting portions 52b (the state shown in FIG. 8). Next, the pressure roller 32 (see FIG. 2) is mounted to the casing 50, and hence the assembling of the fixing unit 13 is completed. Accordingly, since the heating roller 31 restricts the counterclockwise rotation of the separating member 40, and the heating roller 31 prevents the separating member 40 from coming off. The separating member 40 can be mounted to the casing 50 with a simple configuration without providing special forms or members to the separating member 40 and/or the casing 50. It is possible to prevent the separating member 40 from dropping off during the assembly work.

Although the foregoing embodiment shows an example in which the present disclosure is applied to a roller fixing system, the present disclosure is not limited thereto and may be applied to a belt fixing system or a system in which the heating roller or the belt is heated by electromagnetic induction.

In the foregoing embodiment, although the engaging portion is constituted by part of the outer circumferential surface of the first shaft 42a and the arc portions 42d of the second shafts 42b, the present disclosure is not limited thereto. The rotating unit 42 may be constituted by the second shaft 42b, the guide surfaces may be constituted by the two flat portions 42c of the second shaft 42b, and the engaging portion may be constituted by the arc portions 42d and 42e of each second shaft 42b. In the case where the rotating unit 42 is configured as described above, the second engagement supporting portions 52b may be extended in the axial direction of the rotating unit 42 to positions facing the first engagement supporting portions 52a to bring the first engagement supporting portions 52a and the second engagement supporting portions 52b into engagement with the arc portions 42d and 42e of the second shafts 42b. Alternatively, the first engagement supporting portions 52a may be extended in the axial direction to the second engagement supporting portions 52b.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A fixing unit comprising:
a heating member heated by a heat source;
a pressing member pressed against the heating member to form a nip so as to fuse an unfixed toner image on a recording medium subjected to a fixing process;
a casing that includes a supporting portion, wherein the casing rotatably supports the pressing member and the heating member;
a separating member that includes a separation claw that separates the recording medium from a surface of the heating member by making contact with the surface of the heating member;
a rotating unit that rotates the separation claw such that the separation claw makes contact with the surface of the heating member, wherein the rotating unit includes an engaging portion and guide surfaces, and wherein at least part of the engaging portion is cylindrical in shape and an interval between the guide surfaces is smaller than a diameter of the engaging portion;
an urging member including one end secured to the separating member and another end secured to the casing, wherein the urging member contracts to urge the separation claw toward the surface of the heating member;
an engagement supporting portion that rotatably engages the engaging portion; and
an insertion opening extending toward the engagement supporting portion at an interval smaller than the diameter of the engaging portion and larger than the interval between the guide surfaces, wherein the separating member is configured to rotate and retract the guide surfaces from a position facing inner wall surfaces of the insertion opening by inserting the engaging portion into the insertion opening, and wherein the guide surfaces oppose the inner wall surfaces of the insertion opening to move the engaging portion to the engagement supporting portion.

2. The fixing unit according to claim 1, wherein the separating member is one of a plurality of separating members arranged side by side in an axial direction of the heating member.

3. The fixing unit according to claim 1, wherein the rotating unit includes a first cylindrical shaft and a second cylindrical shaft such that the second cylindrical shaft extends from both ends of the first cylindrical shaft, and wherein the second cylindrical shaft has at least one pair of opposing arc portions and at least one pair of flat portions with an interval smaller than a diameter of the first shaft, and wherein when the first cylindrical shaft and the second cylindrical shaft are inserted into the insertion opening by using the flat portions as the guide surfaces: (1) the first cylindrical shaft reaches the engagement supporting portion while maintaining contact with one of the inner wall surfaces of the insertion opening, and when the heating member is mounted on the casing, (2) the separating member rotates to bring part of the outer circumferential surface of the first cylindrical shaft and one of the arc portions of the second cylindrical shaft into engagement with the engagement supporting portion.

4. The fixing unit according to claim 3, wherein a distance between a first engaging supporting portion and a second engagement supporting portion is substantially similar to another distance between one of the arc portions and the first cylindrical shaft.

5. The fixing unit according to claim 1, wherein the separating member has a hook that is provided at the opposite side from the separation claw, and wherein the hook secures one end of the urging member.

6. The fixing unit according to claim 5, wherein the urging member has a coil spring.

7. The fixing unit according to claim 5, wherein the separation claw and the hook are located at the center of the rotating unit in the axial direction.

8. An image forming apparatus including a fixing unit, the fixing unit comprising:
a heating member heated by a heat source;
a pressing member pressed against the heating member to form a nip so as to fuse an unfixed toner image on a recording medium subjected to a fixing process;
a casing that includes a supporting portion, wherein the casing rotatably supports the pressing member and the heating member;
a separating member that includes a separation claw that separates the recording medium from a surface of the heating member by making contact with the surface of the heating member;
a rotating unit rotates the separation claw such that the separation claw makes contact with the surface of the heating member, wherein the rotating unit includes an engaging portion and guide surfaces, and wherein at least part of the engaging portion is cylindrical in shape and an interval between the guide surfaces is smaller than a diameter of the engaging portion;
an urging member including one end secured to the separating member and another end secured to the casing, wherein the urging member contracts to urge the separation claw toward the surface of the heating member;
an engagement supporting portion that rotatably engages the engaging portion; and
an insertion opening extending toward the engagement supporting portion at an interval smaller than the diameter of the engaging portion and larger than the interval between the guide surfaces, wherein the separating member is configured to rotate and retract the guide surfaces from a position facing inner wall surfaces of the insertion opening by inserting the engaging portion into the insertion opening, and wherein the guide surfaces oppose the inner wall surfaces of the insertion opening to move the engaging portion to the engagement supporting portion.

9. The image forming apparatus according to claim 8, wherein the separating member is one of a plurality of separating members arranged side by side in the axial direction of the heating member.

10. The image forming apparatus according to claim 8, wherein the rotating unit includes a first cylindrical shaft and a second cylindrical shaft such that the second cylindrical shaft extends from both ends of the first cylindrical shaft, and wherein the second cylindrical shaft has at least one pair of opposing arc portions and at least one pair of flat portions with an interval smaller than a diameter of the first shaft, and wherein when the first cylindrical shaft and the second cylindrical shaft are inserted into the insertion opening by using the flat portions as the guide surfaces: (1) the first cylindrical shaft reaches the engagement supporting portion while maintaining contact with one of the inner wall surfaces of the insertion opening, and when the heating member is mounted on the casing, (2) the separating member rotates to bring part of the outer circumferential surface of the first cylindrical shaft and one of the arc portions of the second cylindrical shaft into engagement with the engagement supporting portion.

11. The image forming apparatus according to claim 10, wherein a distance between a first engaging supporting portion and a second engagement supporting portion is substantially similar to another distance between one of the arc portions and the first cylindrical shaft.

12. The image forming apparatus according to claim 8, wherein the separating member has a hook that is provided at the opposite side from the separation claw, and wherein the hook secures one end of the urging member.

13. The image forming apparatus according to claim 12, wherein the urging member has a coil spring.

14. The image forming apparatus according to claim 12, wherein the separation claw and the hook are located at the center of the rotating unit in the axial direction.

15. A method comprising:
a fixing unit rotating a pressing member and a heating member, wherein the pressing member and the heating member are rotatably supported in a casing of the fixing unit;
the fixing unit pressing the pressing member against the heating member to form a nip and sending a recording medium through the nip to fuse an unfixed toner image on the recording medium;
the fixing unit moving a rotating unit such that a separating member rotates towards the heating member, wherein the rotating unit moves in response to movement of an urging member; and
the fixing unit separating the recording medium from a surface of the heating member using a separation claw, wherein the separation claw prevents the recording medium from winding around the heating member.

16. The method according to claim 15, wherein the separation claw is located at the center of the rotating unit in the axial direction.

17. The method of claim 15, wherein separating the recording medium from the surface of the heating member includes the separation claw making contact with the surface of the heating member.

18. The method of claim 15, wherein the fixing unit further includes a plurality of separating members arranged side by side in the axial direction of the heating member, and wherein separating the recording medium from the surface of the heating member includes rotating the plurality of separating members in an opposite direction of a rotation of the heating member.

19. The method of claim 15, wherein the rotating unit includes a cylindrical shaft and the casing includes an engagement supporting portion, and wherein moving the rotating unit includes rotating the cylindrical shaft into engagement with the engagement supporting portion.

20. The method according to claim 15, wherein the movement of the urging member includes contracting a coil spring, and wherein one end of the coil spring is attached to the separating member and another end of the coil spring is attached to the casing of the fixing unit.
